(19) United States
(12) Patent Application Publication
(10) Pub. No.: US 2009/0161225 A1
(43) Pub. Date: Jun. 25, 2009

(54) Head Mounting Virtual Display Apparatus

(76) Inventor: Meihong Liu, Guangdong (CN)

Correspondence Address: DAVID AND RAYMOND PATENT FIRM, 108 N. YNEZ AVE., SUITE 128, MONTEREY PARK, CA, 91754, US

(21) Appl. No.: 12/085,821

(22) PCT Filed: Aug. 27, 2007
(86) PCT No.: PCT/CN2007/070561

§ 371 Date: May 28, 2008

(30) Foreign Application Priority Data
Sep. 1, 2006 (CN) 200610062426.5

(51) Int. Cl. G02B 27/02

(52) U.S. Cl. 359/643

(57) ABSTRACT

A display producing virtual visible images of various virtual display products including visual glasses virtual display, head-mounted display, single eye virtual display and virtual 3D display. It consists of a display worn on eyes and mounted on a fixation rack; this display consists of the lens amplifying device and the micro-display; the foresaid lens amplifying device consists of a lens installation rack and the optical lens mounted on the lens installation rack; a micro-display is equipped at rear part of the lens installation rack; the foresaid micro-display displays images through the connection of drive circuit board with the video device, characterized in that: the foresaid optical lens is an aspherical lens; moreover, the above mentioned aspherical lens realizes optical amplification and achromatic function by single aspherical lens. By using this device, a clear amplified image can be seen in front of the eyes of people.

### BACKGROUND OF THE PRESENT INVENTION

1. Field of Invention

The invention concerns the image display technical field, in particular, a display producing virtual visible images of various virtual display products including visual glasses virtual display, head-mounted display, single eye virtual display and virtual 3D display.

2. Description of Related Arts

Most traditional displays adopt direct screen display or projection display for displaying images. Due to the same size of the visible images and the actual images on display, for better visible effect, larger display is required. Therefore, this causes the problems like large dimensions of the display, ponderosity, and large power consumption. So, it is difficult to carry with. In recent years, various helmet-mounted displays, head-mounted displays and visual glasses have been developed. They are more portable than those developed before. Because the optical amplifying system for most of the devices is composed of the multi layer or multi group lens, the optical path has to penetrate multi lens groups. Thus various problems including large optical distortion, difficult production adjustment, poor conformity of the products, large dimensions and weight are caused. This brings in the serious disadvantages concerning manufacture and portability to the virtual displays.

### SUMMARY OF THE PRESENT INVENTION

The purpose for the invention is to provide a single aspherical lens virtual display. The device adopts the brand-new single aspherical lens optical system. After being amplified by the optical system of the invention, the images on the micro-display are projected on to the retina of people for making a large screen and high resolution virtual image in front of the eyes of people.

The technology plan of the invention is realized in the following way: a display worn on eyes and mounted on a fixation rack; this display consists of the lens amplifying device and the micro-display; the foresaid lens amplifying device consists of a lens installation rack and the optical lens mounted on the lens installation rack; a micro-display is equipped at rear part of the lens installation rack; the foresaid micro-display displays images through the connection of drive circuit board with the video device, characterized in that: the foresaid optical lens is an aspherical lens; moreover, the above mentioned aspherical lens realizes optical amplification and achromatic function by single aspherical lens.

This invention is equipped with a fixation rack for wearing on eyes; a display is mounted on front part of it; a lens installation rack is equipped in the foresaid display; a micro-display is equipped at the top of the rack; single aspherical lens is equipped on the other end of it. The foresaid lens is made with plastic or other clear materials. The single aspherical lens can be combined in the following three methods:

1. The first surface is aspherical, while the second surface is spherical.

2. The first surface is spherical, while the second surface is aspherical.

3. Both of the first and second surfaces are aspherical.

The foresaid micro-display can adopt silicon micro crystal display, LCOS and OLED color micro-displays. After the images on the display are amplified by the foresaid optical system, an amplified virtual image is formed in front of the eyes of people.

Comparing with the existing technology, the beneficial effects of the invention are as follows:

1. The single aspherical lens can properly correct spherical aberration, coma, color difference, aberrance, and field curvature for comfortable watching at.

2. The single aspherical lens features compact size, light in weight, low cost. The cost counts for only ⅓ of the current optical systems.

3. The single lens enables a high light penetrating rate enhanced by 4 times compared with the current optical systems.

4. The single lens is with the advantage of simple assembly, and thus the production efficiency and quality have been greatly improved owing to the property of simple assembly.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

Further explanation to the invention will be stated below combining with the attached figures and the mode of carrying out the invention:

FIG. 1 is an observation principle diagram of virtual visual image of this invention;

FIG. 2 is an imaging optical path principle diagram of embodiment one of this invention;

FIG. 3 is an illustration of the lens installation rack of embodiment one of this invention;

FIG. 4 is an imaging optical path principle diagram of embodiment two of this invention;

FIG. 5 is an illustration of the lens installation rack of embodiment two of this invention;

FIG. 6 is an illustration of the first kind of fixation rack of embodiment of this invention;

FIG. 7 is an illustration of the second kind of fixation rack of embodiment of this invention;

FIG. 8 is an illustration of the third kind of fixation rack of embodiment of this invention.

### DETAILED DESCRIPTION OF THE PREFERRED EMBODIMENT

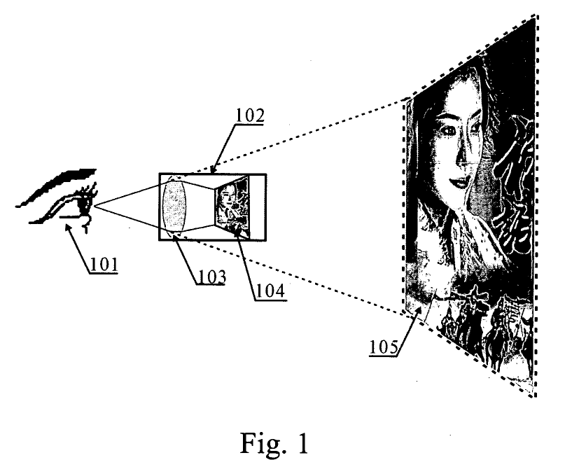

As shown in FIG. 1, the principle of this invention: Place lens installation rack 102 in front of eyes 101 of people. The micro-display 104 is mounted at the front part of the lens rack. The aspherical lens 103 of the invention is equipped between the eyes of people and the micro-display. What is visible to eyes of people is the virtual image 105 which is amplified and distance enlarged at rear part of the display 104 after optical treatment by the single aspherical lens 103. According to the visual characteristics of eyes of people, the virtual and amplified image visible to eyes of people is with the same visual effect as the actual image placed at the position of the virtual image in same size. The micro-display can adopt silicon micro crystal display, LCOS and OLED color micro-displays. This display is connected with the corresponding display drive circuit for displaying color image.

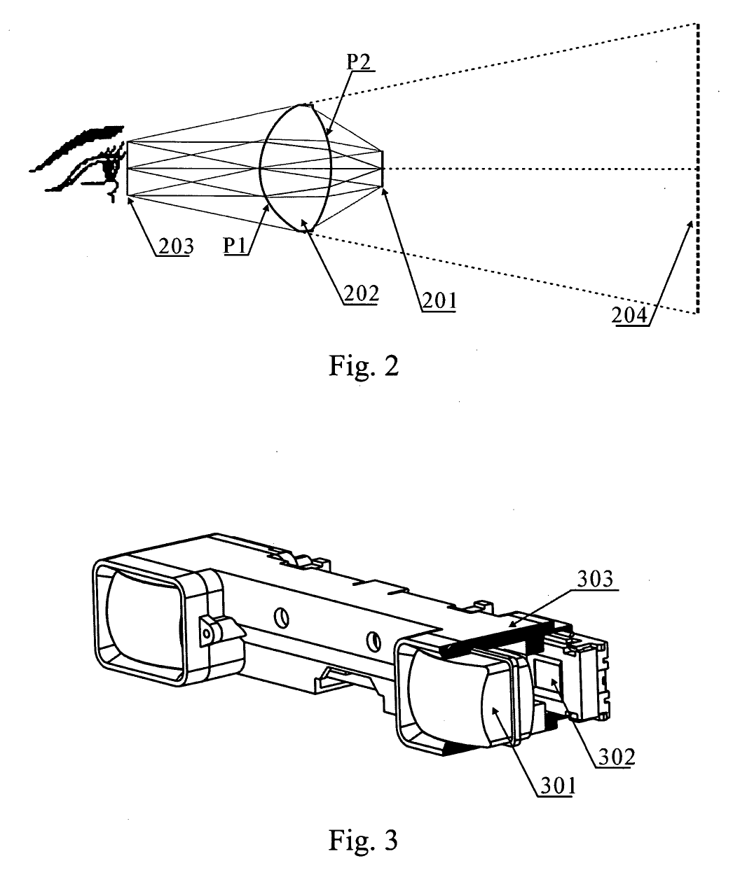

As shown in FIG. 2, it is the imaging optical path principle diagram. 201 is the micro-display; 202 is the single aspherical lens; 203 is the exit pupil, meaning the position to place eyes of people, and the exit pupil corresponds to the pupil of human eyes. In this optical system, the micro-display 201 locates at focal plane of the optical system. The light from it passes through the single aspherical lens 202, and finally enters into the exit pupil 203 (pupil of human eyes). After being amplified by the optical system, the image on the micro-display becomes into virtual image (1-2 m far). The amplified virtual image on the micro-display can be seen with eyes of people at the position of the exit pupil.

Key points of the optical system in this invention: Only single plastic lens is applied. The design takes full use of nth aspherical power of parameters ranging from the power of fourth to the sixteenth; meanwhile the thickness of the lens is enlarged for more easily achieving large exit pupil diameter and distance. The single aspherical lens can be combined in the following three methods:

Observe from the surface:

1) Both of the first surface P1 and the second surface P2 are aspherical.

2) The first surface P1 is aspherical, while the second surface P2 is spherical.

3) The first surface P1 is spherical, while the second surface P2 is aspherical.

Advantages of the single plastic lens:

a) The single aspherical lens can properly correct spherical aberration, coma, color difference, aberrance, and field curvature for comfortable watching at.

b) The single aspherical lens features compact size, light in weight, low cost. The cost counts for only ⅓ of the current optical systems.

c) The single lens enables a high light penetrating rate enhanced by 4 times compared with the current optical systems.

d) The single lens is with the advantage of simple assembly, and thus the production efficiency and quality have been greatly improved owing to the property of simple assembly.

As shown in FIG. 3, it is an illustration of lens installation rack of embodiment one of this invention. The aspherical lens 301 is equipped at front part of the lens installation rack 303; the micro-display 302 is equipped at the rear part; the lens rack is mounted on to the fixation rack and placed in front of eyes of people. Through the aspherical lens at the front part of the lens rack, people can see an equivalent large display screen at the position 1-2 m far with naked eyes. The fixation rack can be in various forms including glasses, head-mounted and single eye fixed type.

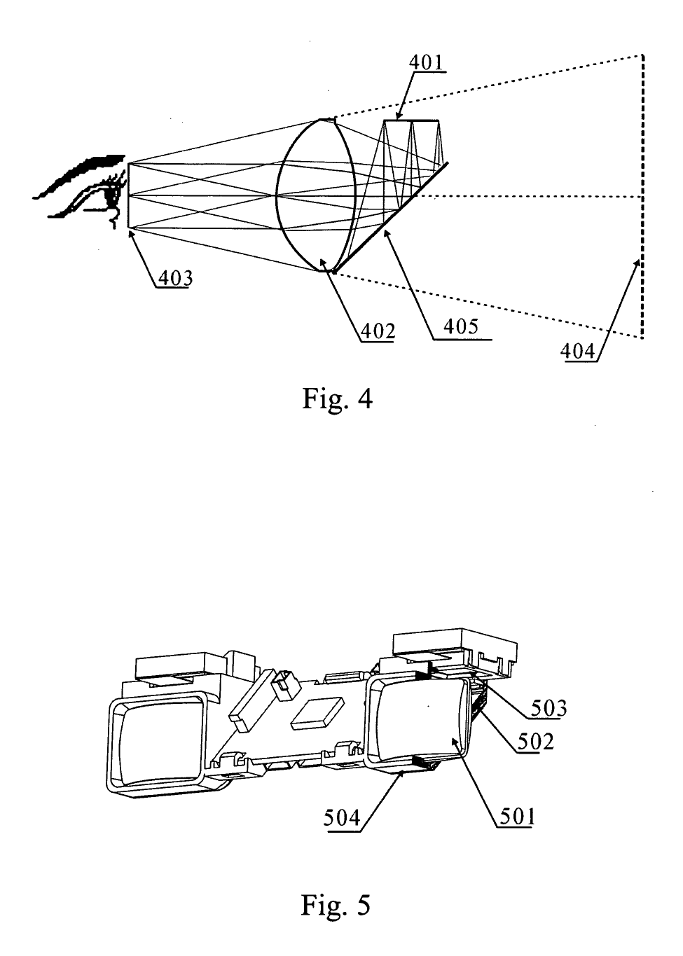

As shown in FIG. 4, it is the imaging optical path principle diagram of embodiment two of the invention. 1 is the micro-display; 2 is the reflector; 3 is the single aspherical lens; 4 is the exit pupil, meaning the position to place eyes of people, and the exit pupil corresponds to the pupil of human eyes. In this optical system, the liquid crystal display 1 locates at focal plane of the optical system. The light from it passes through the reflector and the single aspherical lens, and finally enters into the exit pupil 4 (pupil of human eyes). After being amplified by the optical system, the image on the liquid crystal display becomes into virtual image (1-2 m far). The amplified virtual image on the micro-display can be seen with eyes of people at the position of the exit pupil.

As shown in FIG. 5, it is an illustration of lens installation rack of embodiment one of this invention. The key points of this optical system are: with the pre-condition of the first kind of optical system, in case of over long back focus (indicating the distance between the lens 403 and the micro-display 401), the size is reduced by equipping a reflector 405 between them two for folding optical path. After this treatment, the front and back distances for the whole lens installation rack is greatly shortened comparing with the first kind of lens installation rack. Due to the lens refraction, the image displayed by the micro-display is required to be mirror image. Only in this way, the virtual image 404 seen by people is the positive image.

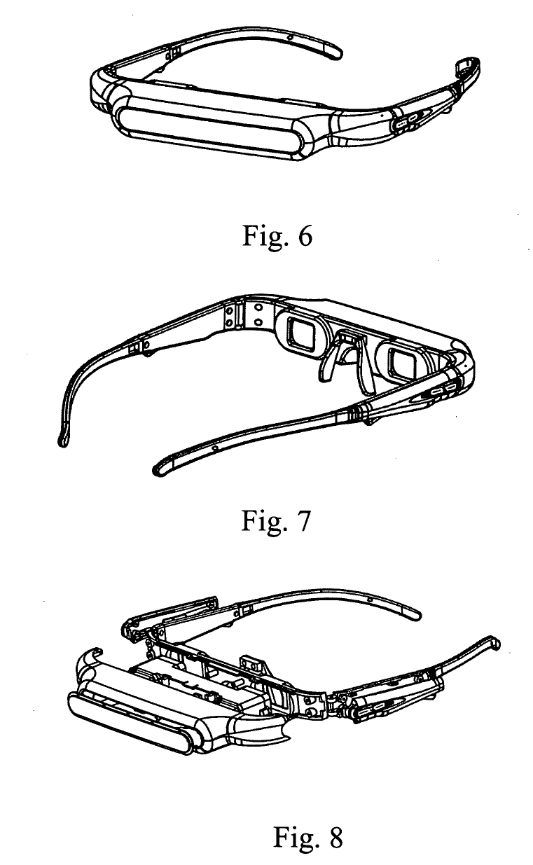

As shown in FIGS. 6, 7 and 8, it is an illustration of the fixation rack of the invention. The fixation rack is the visual glasses enabling to directly wear on as the spectacles. Other types of fixation rack including head-mounted type and single eye fixation type can also be adopted. This paper will not list them all further in details.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A head mounting virtual display apparatus consisting of a display worn on eyes and mounted on a fixation rack; this display consists of the lens amplifying device and the micro-display; the foresaid lens amplifying device consists of a lens installation rack and the optical lens mounted on the lens installation rack; a micro-display is equipped at rear part of the lens installation rack; the foresaid micro-display displays images through the connection of drive circuit board with the video device, characterized in that: the foresaid optical lens is an aspherical lens; moreover, the above mentioned aspherical lens realizes optical amplification and achromatic function by single aspherical lens.

2. The head mounting virtual display apparatus as set forth in claim 1, characterized in that: minimum one of the two sides of the foresaid aspherical lens is aspherical.

3. The head mounting virtual display apparatus as set forth in claim 1, characterized in that: the foresaid aspherical lens adopts aspherical nth power parameter design ranging from the power of fourth to the sixteenth; meanwhile the thickness of the lens is enlarged for more easily achieving large exit pupil diameter and distance.

4. The head mounting virtual display apparatus as set forth in claim 1, characterized in that: the foresaid lens is made with plastic or other clear materials.

5. The head mounting virtual display apparatus as set forth in claim 1, characterized in that: between the aspherical lens and the micro-display, there may be or may not be a reflector equipped.
